(19) United States
(12) Patent Application Publication
(10) Pub. No.: US 2005/0068682 A1
(43) Pub. Date: Mar. 31, 2005

(54) Head actuator assembly and disk drive provided with the same

(75) Inventor: Yasutaka Sasaki, Tachikawa-shi (JP)

Correspondence Address: FOLEY & LARDNER, 2029 CENTURY PARK EAST, SUITE 3500, LOS ANGELES, CA, 90067, US

(73) Assignee: KABUSHIKI KAISHA TOSHIBA

(21) Appl. No.: 10/877,227

(22) Filed: Jun. 24, 2004

(30) Foreign Application Priority Data
Sep. 30, 2003 (JP) 2003-342325

(51) Int. Cl. G11B 5/55

(52) U.S. Cl. 360/264.7

(57) ABSTRACT

A head actuator assembly has an arm, a cylindrical hub, a relay flexible printed circuit (FPC) mounted on the arm and having a first connecting portion, a main FPC having a second connecting portion for connection to the first connecting portion of the relay FPC, and a reinforcing plate having a first part with a circular opening and a second part with a projection. The second connecting portion of the relay FPC is connected to the second part of the reinforcing plate for supporting the second connecting portion. The circular opening of the first part receives the cylindrical hub for aligning the reinforcing plate with respect to the arm.

### CROSS-REFERENCE TO RELATED APPLICATIONS

This application is based upon and claims the benefit of priority from the prior Japanese Patent Application No. 2003-342325, filed Sep. 30, 2003, the entire contents of which are incorporated herein by reference.

### BACKGROUND OF THE INVENTION

This invention relates to a head actuator assembly used in a disk drive and the disk drive provided with the same.

In recent years, disk drives, such as magnetic disk drives, optical disk drives, etc., have been widely used as external recording devices or image recording devices for computers.

A magnetic disk drive, for example, generally comprises a magnetic disk located in a casing, a spindle motor that supports and rotates the disk, a head actuator that supports a magnetic head, a voice coil motor that drives the head actuator, a circuit board unit, etc.

The head actuator is provided with a bearing portion attached to the casing and an arm that is stacked on and extends from the bearing portion. The magnetic head is mounted on the arm by means of a suspension. The circuit board unit has a base portion, on which a head IC, connector, etc. are mounted, and a main flexible printed circuit board (hereinafter referred to as main FPC) that extends close to the bearing portion from the base portion. An extended end portion of the main FPC constitutes a connecting portion, which is provided with a plurality of connecting pads and an opening through which a screw is passed. This connecting portion is screwed to the bearing portion of the head actuator through the opening.

A relay flexible printed circuit board (hereinafter referred to as relay FPC) is fixed on the arm and the suspension of the head actuator. One end of the relay FPC is connected to the magnetic head, and the other end to the connecting portion of the main FPC. A plurality of connecting pads are arranged on the other end of the relay FPC. The relay FPC and the main FPC are connected electrically and mechanically to each other with the connecting pads of the relay FPC soldered to the connecting pads on the connecting portion of the main FPC. The magnetic head that is supported on the suspension is connected electrically to the circuit board unit through the relay FPC and the main FPC.

In the magnetic disk drive constructed in this manner, the magnetic head is moved to an optional radial position on the magnetic disk in rotation or moved onto and positioned on an optional track by the head actuator. In this state, the magnetic head reads from and writes information in the magnetic disk.

With the recent miniaturization of disk drives, various modern components including head actuators have been reduced in size. In the case of these small-sized head actuators, it is hard to secure a space for the connecting portion of the main FPC to be screwed to the bearing portion. Further, a space for connecting operation is too narrow to ensure satisfactory working efficiency. A method to cope with this problem is proposed in Jpn. Pat. Appln. KOKAI Publication No. 10-092125. According to this method, the connecting portion of the main FPC is held in the bearing portion of the head actuator without using screws when it is fixed. In this fixing method, however, the respective connecting portions of the main FPC and the relay FPC must be soldered together. Thus, the connecting operation is troublesome and requires skill.

A novel head actuator is proposed in Jpn. Pat. Appln. KOKAI Publication No. 2001-143246. In this case, the respective connecting portions of the main FPC and the relay FPC are superposed on each other at the junction between the suspension and the arm. The connecting portions are pressure-bonded together by fixing a fixing plate to them by caulking from above. According to this head actuator, the main FPC and the relay FPC need not be soldered. It is difficult, however, to align the connecting portions accurately, so that the reliability lowers. Since the fixing plate is fixed by caulking, moreover, the junction cannot be disassembled with ease, and repairing the head actuator is a hard task.

### BRIEF SUMMARY OF THE INVENTION

In accordance with the embodiments of the invention, the head actuator assembly is constructed such that the connecting portions of the main FPC and the relay FPC may be electronically connected and mechanically secured together without the need for solder or caulking. Further, the electrically connected and mechanically secured portions of the respective FPC are each secured to bearing assembly portions in a self orienting or self aligning manner and a structure is provided for providing relatively rigid support for each FPC. The self orientation may be achieved, for example using a circular opening in a reinforcing plate in the case of the main FPC and a circular opening in the arm of the head actuator in the case of the relay PFC.

A head actuator assembly according to an aspect of the invention comprises a head actuator which supports a head and a main flexible printed circuit board connected to the head actuator. The head actuator includes a bearing portion, an arm extending from the bearing portion and having a proximal end portion with an opening through which the bearing portion is passed, a suspension extending from an extended end of the arm, the head set on the extended end of the suspension, a relay flexible printed circuit board mounted on the arm and the suspension and having one end portion connected electrically to the head and a connecting portion overlapping the proximal end portion of the arm, and a spacer member stacked on the proximal end portion of the arm and having an opening through which the bearing portion is passed. The main flexible printed circuit board has a connecting end portion provided with a connecting portion and a reinforcing plate fixed overlapping the connecting end portion and the connecting portion. The reinforcing plate is stacked between the proximal end portion of the arm and the spacer member and has an opening through which the bearing portion is passed. The respective connecting portions of the relay flexible printed circuit board and the main flexible printed circuit board are sandwiched between the proximal end portion of the arm and the reinforcing plate and connected electrically to each other.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing the interior of an HDD according to a first embodiment of the invention;

FIG. 2 is a perspective view showing a head actuator assembly in the HDD;

FIG. 3 is a perspective view showing an HGA of a head actuator;

FIG. 4 is an exploded perspective view showing the head actuator;

FIG. 5 is an exploded perspective view showing a main FPC and a reinforcing plate of an FPC unit of the HDD;

FIGS. 6A, 6B and 6C are perspective views individually showing manufacturing processes for the main FPC and the reinforcing plate;

FIG. 7 is a sectional view of the head actuator taken along line VII-VII of FIG. 2;

FIG. 8 is a perspective view showing a head actuator assembly according to a second embodiment of the invention;

FIG. 9 is an exploded perspective view showing the head actuator assembly according to the second embodiment;

FIG. 10 is an exploded perspective view showing a main FPC and reinforcing plates of an FPC unit according to the second embodiment;

FIG. 11 is a development showing the main FPC and the reinforcing plates;

FIG. 12 is a sectional view of the head actuator taken along line XII-XII of FIG. 8;

FIG. 13 is a perspective view showing a modification of an arm of an HGA;

FIG. 14 is a perspective view showing another modification of the arm of the HGA;

FIG. 15 is a perspective view showing another modification of the arm of the HGA;

FIG. 16 is a perspective view showing another modification of the arm of the HGA;

FIG. 17 is a perspective view showing an HGA of a head actuator assembly according to a third embodiment of the invention; and

FIG. 18 is an exploded perspective view showing the head actuator assembly according to the third embodiment.

### DETAILED DESCRIPTION OF THE INVENTION

A head actuator assembly according to a first embodiment of this invention and a magnetic disk drive, which is provided with the same and applied to a hard disk drive (hereinafter referred to as HDD), will now be described in detail with reference to the accompanying drawings.

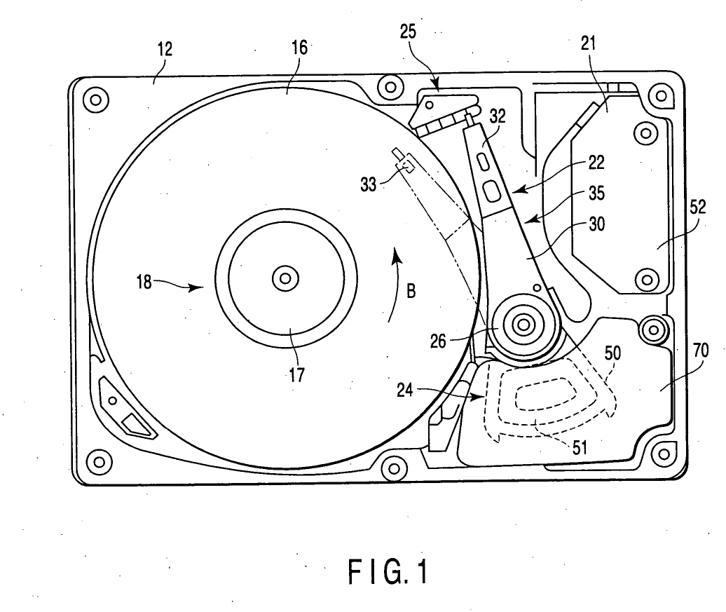

As shown in FIG. 1, the HDD comprises a casing 12 in the form of an open-topped rectangular box and a top cover (not shown). The top cover is fixed to the casing by a plurality of screws and closes a top opening of the casing.

The casing 12 houses a magnetic disk 16 for use as a recording medium, a spindle motor 18, a magnetic head 33, a head actuator 22, a voice coil motor (hereinafter referred to as VCM) 24, etc. The motor 18 serves as a drive element that supports and rotates the magnetic disk. The magnetic head writes in and reads information from the magnetic disk 16. The head actuator 22 supports the magnetic head for movement with respect to the magnetic disk 16. The VCM 24 is used to rock and position the head actuator 22. The casing 12 further houses a ramp load mechanism 25, a flexible printed circuit board unit (hereinafter referred to as FPC unit) 21, etc. The mechanism 25 holds the magnetic head in a retreated position off the magnetic disk 16 when the magnetic head is moved to the outermost periphery of the magnetic disk. The FPC unit 21 is mounted with a read/write amplifier or the like as a processing circuit for recording/reproducing signals. A printed circuit board (not shown) for controlling the operation of the spindle motor 18, the VCM 24, and the magnetic head through the FPC unit 21 is screwed to the outer surface of the bottom wall of the casing 12.

The magnetic disk 16 has a magnetic recording layer formed on its surface. The disk 16 is fitted on a hub (not shown) of the spindle motor 18 and fixed to the hub by a clamp spring 17. As the motor 18 is driven, the disk 16 is rotated in the direction of arrow B at a given speed, e.g., at 4,200 rpm.

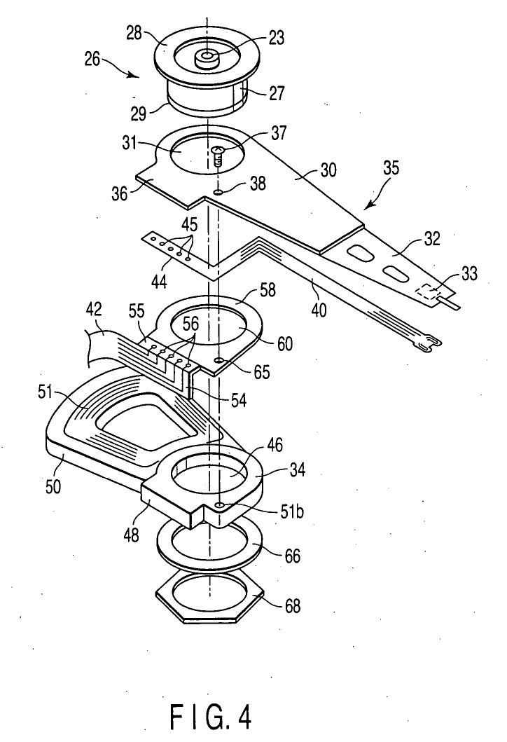

As shown in FIGS. 1 to 4, the head actuator 22 is provided with a bearing assembly 26 fixed on the bottom wall of the casing 12, a head gimbals assembly (hereinafter referred to as HGA) 35 supported on the bearing assembly, and a spacer ring 34. The bearing assembly 26 that serves as a bearing portion has a pivot 23 on the bottom wall of the casing 12 and a cylindrical hub 27, which is rotatably supported on the pivot by a pair of bearings. An annular flange 28 is formed on the upper end of the hub 27, and a thread portion 29 is formed around the lower end portion of the hub.

The HGA 35 is provided with an arm 30 attached to the hub 27, a suspension 32 extending from the arm, and a magnetic head 33 supported on the extended end of the suspension by means of a gimbals portion (not shown). The arm 30 is formed of a thin flat plate of a stainless-steel material, such as SUS304, having a thickness of about 200 μm. A circular opening 31 is formed in one end or the proximal end portion of the arm 30. The arm 30 integrally has a projection 36 that protrudes outward from its proximal end portion in the diametrical direction of the hub 27. A positioning hole 38 to be penetrated by a positioning screw 37 is formed in that part of the proximal end portion of the arm 30 which is situated near the projection 36.

The suspension 32 is formed of an elongate leaf spring with a thickness of 20 to 100 μm, and its proximal end is fixed to the distal end of the arm 30 by spot welding or adhesive bonding and extends from the arm. The suspension 32 and the arm 30 may be integrally formed of the same material.

The magnetic head 33 has a substantially rectangular slider (not shown) and a recording and reproducing MR (magnetic resistance) head formed on the slider. It is fixed to the gimbals portion that is formed on the distal end portion of the suspension 32. The magnetic head 33 has four electrodes (not shown).

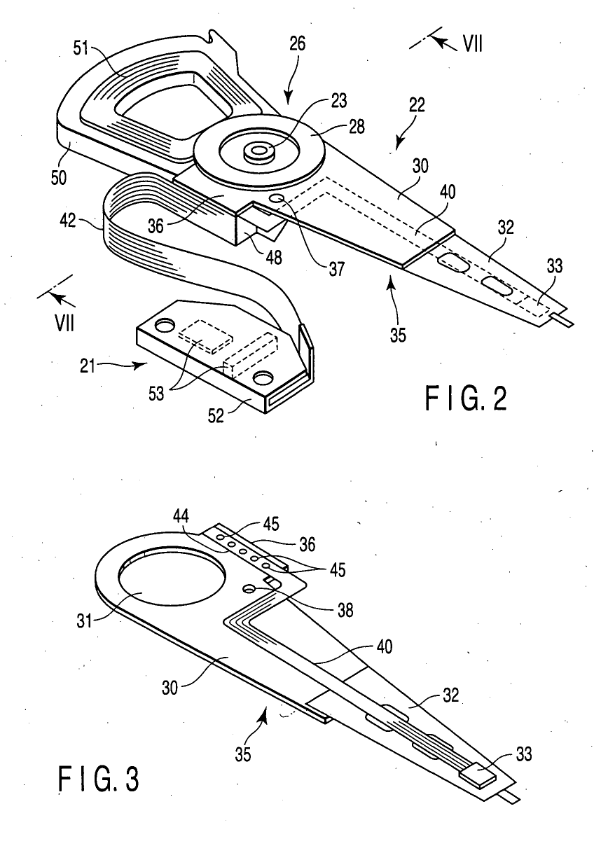

As shown in FIGS. 2 to 4, the magnetic head 33 is connected electrically to a main FPC 42 (mentioned later) through a relay FPC 40. The relay FPC 40 is stacked on the respective inner surfaces of the arm 30 and the suspension 32 of the head actuator 22, and extends from the distal end of the suspension to the proximal end portion of the arm. The relay FPC 40 has the form of an elongate belt as a whole, and its distal end is connected electrically to the magnetic head 33. The other end portion of the relay FPC 40 is bent like a crank, extends outward from the proximal end portion of the arm 30, and is then put on the projection 36 of the arm. The end portion of the relay FPC 40 that is situated on the projection 36 constitutes a connecting portion 44. The connecting portion 44 has a plurality of connecting pads 45, which are arranged at spaces in its longitudinal direction. The connecting portion 44 extends parallel to the inner surface of the arm 30, and its free end is adhesively bonded or spot-welded to the projection 36. The connecting pads 45 are located on the surface opposite from the arm 30.

The spacer ring 34 that serves as a spacer member has an opening 46 through which the hub 27 is passed, a projection 48 corresponding in shape to the projection 36 of the arm 30, and a support frame 50 that extends in the direction opposite from that of the arm 30. The spacer ring 34 is integrally formed of synthetic resin or the like. A voice coil 51 that constitutes a part of the VCM 24 is embedded in the support frame 50. The spacer ring 34 has a tapped hole 51b that is formed in a position corresponding to the positioning hole 38 of the arm 30.

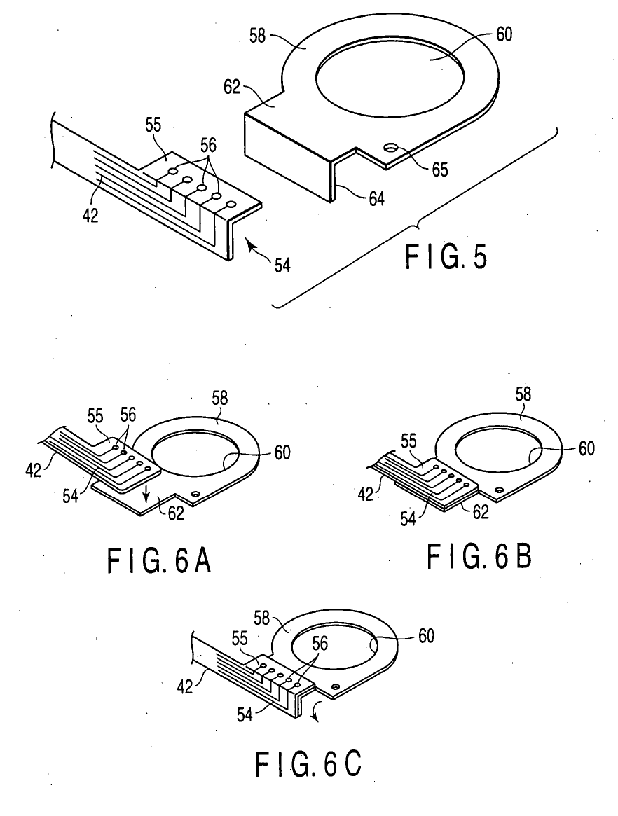

As shown in FIGS. 2, 4 and 5, the FPC unit 21 has a base portion 52 and the main FPC 42 in the form of an elongate belt extending from the base portion. The base portion 52 is formed by bending a flexible printed circuit board into a substantially rectangular shape. The base portion 52 and the main FPC 42 are formed integrally from the common flexible printed circuit board. A plurality of electronic components 53, such as a head amplifier, connector, etc., are mounted on the base portion 52. The base portion 52 is fixed on the bottom wall of the casing 12.

The extended end portion of the main FPC 42 that extends from the base portion 52 constitutes a connecting end portion 54. The connecting end portion 54 is provided integrally with a rectangular connecting portion 55 that projects upward. A plurality of connecting pads 56 are provided on the surface of the connecting portion 55. They are arranged at spaces in the longitudinal direction of the connecting portion 55. The connecting pads 56 correspond in number and in position to the connecting pads 45 of the relay FPC 40. The pads 56 are connected electrically to the base portion 52 through a conductor pattern of the main FPC 42.

The bearing assembly 26 is provided with a ring-shaped reinforcing plate 58 of metal. The reinforcing plate 58 has a first plate portion that extends parallel to the surface of the arm 30. The first plate portion has an opening 60 through which the hub 27 of the bearing assembly 26 is passed and a projection 62 that extends diametrically outward from the opening. The distal end portion of the projection 62 is bent square, and it constitutes a lug 64 that serves as a second plate portion. The reinforcing plate 58 has a positioning hole 65 in a position corresponding to the positioning hole 38 of the arm 30.

The connecting end portion 54 of the main FPC 42 is bonded to the lug 64 of the reinforcing plate 58. The connecting portion 55 extends at right angles to the connecting end portion 54, and is bonded on the projection 62 of the reinforcing plate 58. Thus, the connecting portion 55 of the main FPC 42 is located parallel to the surface of the reinforcing plate 58, while the connecting end portion 54 is located square to the surface of the reinforcing plate. The connecting pads 56 on the connecting portion 55 are situated on the surface opposite from the reinforcing plate 58 and are exposed to the outside.

In manufacturing processes, as shown in FIGS. 6A, 6B and 6C, the flat reinforcing plate 58 is prepared, and the connecting end portion 54 and the connecting portion 55 of the main FPC 42 are stuck to the projection 62 of the reinforcing plate. Thereafter, the distal end portion of the projection 62, along with the connecting portion 55, is bent square to form the lug 64.

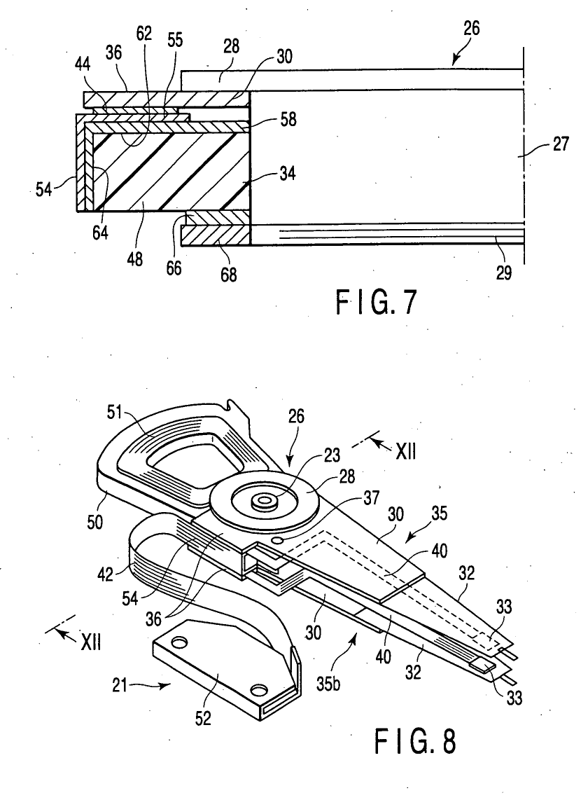

The arm 30, reinforcing plate 58, and spacer ring 34 constructed in this manner are stacked to one another when they are mounted on the hub 27 of the bearing assembly 26. The arm 30, having the magnetic head 33, suspension 32, and relay FPC 40 thereon, as shown in FIGS. 2, 4 and 7, is fitted on the hub 27 that is passed through the opening 31. The arm 30 is stacked on the flange 28 in the axial direction of the hub 27. The reinforcing plate 58 is stacked on the proximal end portion of the arm 30 when it is fitted on the hub 27 that is passed through the opening 60. The spacer ring 34 is stacked on the reinforcing plate 58 when it is fitted on the hub 27 that is passed through the opening 46.

The arm 30, reinforcing plate 58, and spacer ring 34 that are fitted on the hub 27 are sandwiched between the flange 28 and a combination of a washer 66, which is fitted on the lower end portion of the hub 27, and a nut 68, which is threadedly engaged with the thread portion 29 of the hub 27. They are fixedly held on the hub 27. The positioning screw 37 is passed from above through the positioning hole 38 in the arm 30 and the positioning hole 65 in the reinforcing plate 58, and is screwed in the tapped hole 51b of the spacer ring 34. Thus, the arm 30, reinforcing plate 58, and spacer ring 34 are located in given relative positions with respect to the circumferential direction of the hub 27. A jig may be used in place of the positioning screw for positioning those elements with respect to the left-right direction and circumferential direction.

The arm 30 extends outward in the circumferential direction from the hub 27 and can move integrally with the hub 27. The connecting end portion 54 of the main FPC 42 is connected to the head actuator 22. The respective projections 36, 62 and 48 of the arm 30, reinforcing plate 58, and spacer ring 34 are stacked on one another. The respective connecting portions 44 and 55 of the relay FPC 40 and the main FPC 42 are sandwiched between the respective projections 36 and 62 of the arm 30 and the reinforcing plate 58. Further, the connecting portions 44 and 55 and the projection 62 of the reinforcing plate 58 are sandwiched between the respective projections 36 and 48 of the arm 30 and the spacer ring 34. Thus, the connecting pads 45 on the connecting portion 44 and the connecting pads 56 on the connecting portion 55 are pressed against each other and connected mechanically and electrically. In other words, the head actuator 22 and the FPC unit 21 are connected electrically and mechanically to each other to form a head actuator assembly. An anisotropic conductive film may be sandwiched between the connecting portions 44 and 55 in order to secure the electrical connection between the connecting pads 45 and 56.

As seen from FIG. 1, the head actuator assembly, which comprises the head actuator 22 and the FPC unit 21 connected to it, is located in the casing 12, and the bearing assembly 26 of the actuator 22 is fixed on the bottom wall of the casing. The base portion 52 of the FPC unit 21 is fixed on the bottom wall of the casing 12 by screwing.

The voice coil 51 that is fixed to the support frame 50 is situated between a pair of yokes 70 that are fixed on the casing 12. The coil 51, along with the yokes 70 and a magnet (not shown) fixed to one of the yokes, constitutes the VCM 24. If the voice coil 51 is energized when the HDD is on, the head actuator 22 rotates, whereupon the magnetic head 33 is moved onto and positioned on a desired track of the magnetic disk 16.

According to the HDD constructed in this manner, the respective connecting portions 55 and 44 of the main FPC 42 and the relay FPC 40 are stacked in a position corresponding to the bearing assembly 26. They are connected mechanically and electrically to each other as they are held between the proximal end portion of the arm 30 and the reinforcing plate 58. Thus, the main FPC 42 and the relay FPC 40 can be connected mechanically and electrically to each other with ease and in a short time without using solder or the like. The arm 30 and the reinforcing plate 58, to which the relay FPC 40 and the main FPC 42 are attached, have the openings 31 and 60, respectively. They are positioned with respect to each other with the hub 27 of the bearing assembly 26 passed through these openings. The arm 30, reinforcing plate 58, and spacer ring 34 are positioned with respect to each other by means of the positioning screw 37 that is screwed into the tapped hole 51 through the positioning holes 38 and 65. Thus, the respective connecting portions 55 and 44 of the main FPC 42 and the relay FPC 40 can be positioned accurately and connected securely.

The respective connecting portions 55 and 44 of the main FPC 42 and the relay FPC 40 can be easily disconnected by removing the nut 68 of the bearing assembly 26 and disjoining the arm 30, reinforcing plate 58, and spacer ring 34. If the head actuator assembly breaks down, therefore, it can be easily repaired without damaging its components and other components of the HDD.

The following is a description of an HDD according to a second embodiment of the invention. Like reference numerals are used to designate like portions of the first and second embodiments, and a detailed description of those portions is omitted.

According to the second embodiment, as shown in FIGS. 8 to 11, the head actuator assembly is provided with another HGA 35b besides an HGA 35. The HGAs 35 and 35b have the same configuration and are arranged symmetrically to each other. More specifically, the HGA 35b has an arm 30 attached to a hub 27 of a bearing assembly 26, a suspension 32 extending from the arm, and a magnetic head 33 supported on the extended end of the suspension by means of a gimbals portion. The arm 30 has a circular opening 31 in its proximal end portion, a projection 36 that protrudes outward from its proximal end portion in the diametrical direction of the hub 27, and a tapped hole 38b formed near the projection 36. A relay FPC 40 is mounted on the respective inner surfaces of the arm 30 and the suspension 32, and extends from the distal end of the suspension to the proximal end portion of the arm. The distal end of the relay FPC 40 is connected electrically to the magnetic head 33. The other end portion of the relay FPC 40 is bent like a crank, extends outward from the proximal end portion of the arm 30, and is then put on the projection 36 of the arm. The end portion of the relay FPC 40 that is situated on the projection 36 constitutes a connecting portion 44. The connecting portion 44 has a plurality of connecting pads 45, which are arranged at spaces in its longitudinal direction. The connecting portion 44 extends parallel to the inner surface of the arm 30, and its free end is adhesively bonded or spot-welded to the projection 36. The connecting pads 45 are located on the surface opposite from the arm 30.

In a spacer ring 34, a positioning hole 51b is formed in place of a tapped hole in a position corresponding to a positioning hole 38 of the arm 30.

A connecting end portion 54 of a main FPC 42 is provided integrally with a rectangular connecting portion 55 that projects upward and a rectangular connecting portion 55b that projects downward. A plurality of connecting pads 56 are located on each of the respective surfaces of the connecting portion 55 and 55b. They are arranged at spaces in the longitudinal direction of the connecting portions. The connecting pads 56 correspond in number and in position to the connecting pads 45 of the relay FPC 40. The pads 56 are connected electrically to a base portion 52 through a conductor pattern of the main FPC 42.

An FPC unit 21 is provided with another reinforcing plate 58b besides a reinforcing plate 58. The reinforcing plate 58b, which is formed of a ring-shaped metal sheet, has an opening 60b through which the hub 27 of the bearing assembly 26 is passed and a projection 62b that extends diametrically outward from the opening 60. Further, the sheet 58b is formed having a positioning hole 65b in a position corresponding to the positioning hole 38 of the arm 30. A lug 64 is not shown.

The connecting end portion 54 of the main FPC 42 is adhesively bonded to the lug 64 of the reinforcing plate 58. The connecting portion 55 extends at right angles to the connecting end portion 54, and is bonded on a projection 62 of the reinforcing plate 58. Thus, the connecting portion 55 of the main FPC 42 is located parallel to the surface of the reinforcing plate 58, while the connecting end portion 54 is located square to the surface of the reinforcing plate. The connecting pads 56 on the connecting portion 55 are situated on the surface opposite from the reinforcing plate 58 and are exposed to the outside.

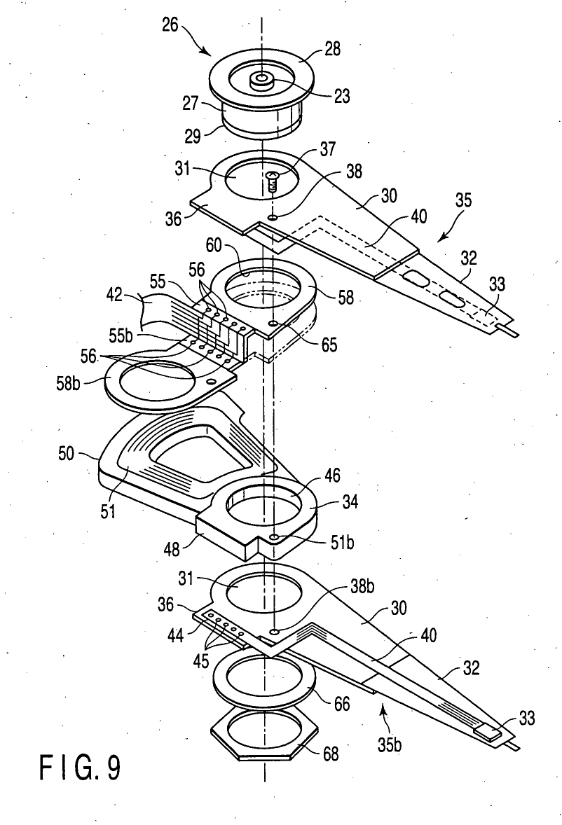

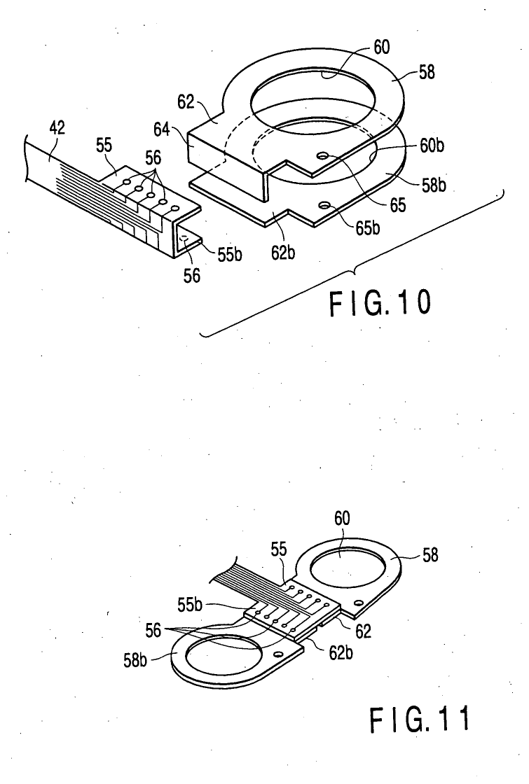

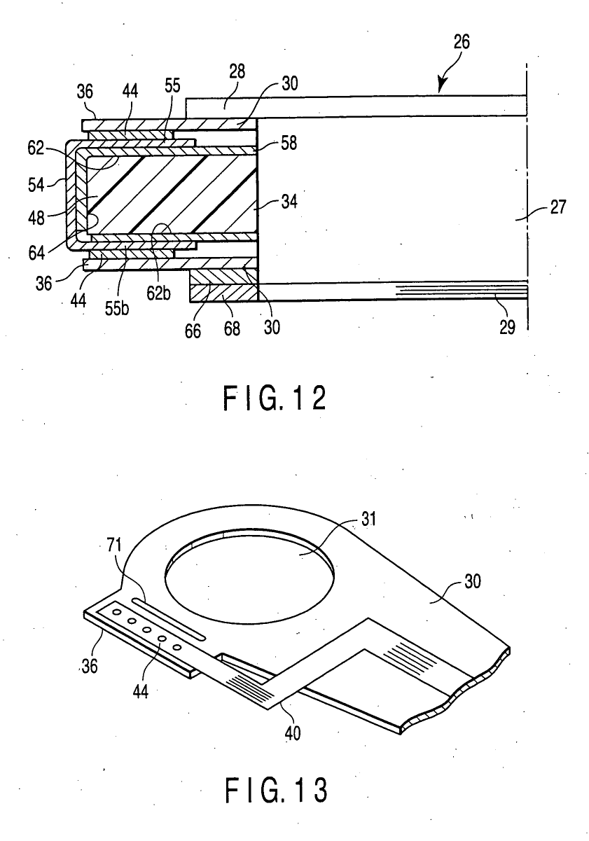

The other connecting portion 55b extends at right angles to the connecting end portion 54, and is bonded on the projection 62b of the reinforcing plate 58b. The connecting portion 55b is located parallel to the surface of the reinforcing plate 58b, and the connecting pads 56 are situated on the surface opposite from the reinforcing plate 58b and are exposed to the outside. The projection 62b of the reinforcing plate 58b is located with a slight gap from the lug 64 of the reinforcing plate 58, and connects with the lug 64 by means of the main FPC 42. The flexibility of the main FPC 42 enables the reinforcing plate 58b to rock between a position in which it is open at an angle of 180 degrees to the reinforcing plate 58, as shown in FIG. 9, and a position in which it coaxially faces the reinforcing plate, as shown in FIG. 10.

In manufacturing processes, as shown in FIG. 11, the flat reinforcing plate 58 and the reinforcing plate 58b are prepared, the connecting end portion 54 and the connecting portion 55 of the main FPC 42 are stacked on the projection 62 of the reinforcing plate 58, and the other connecting portion 55b is stacked on the projection 62b of the reinforcing plate 58b. Thereafter, the distal end portion of the projection 62 of the reinforcing plate 58, along with the connecting portion 55, is bent square to form the lug 64.

The two HGAs 35 and 35b, reinforcing plates 58 and 58b, and spacer ring 34 are stacked to one another when they are mounted on the hub 27 of the bearing assembly 26. The arm 30 of the HGA 35 is stacked on a flange 28 in the axial direction of the hub 27 when it is fitted on the hub 27 that is passed through the opening 31. The reinforcing plate 58 is stacked on the proximal end portion of the arm 30 when it is fitted on the hub 27 that is passed through an opening 46.

Further, the reinforcing plate 58b is stacked on the spacer ring 34 when it is fitted on the hub 27 that is passed through the opening 60b. The arm 30 of the other HGA 35b is stacked on the reinforcing plate 58b when it is fitted on the hub 27 that is passed through the opening 31.

The arm 30, reinforcing plate 58, spacer ring 34, reinforcing plate 58b, and the other arm 30 that are fitted on the hub 27 are sandwiched between the flange 28 and a combination of a washer 66, which is fitted on the lower end portion of the hub 27, and a nut 68, which is threadedly engaged with a thread portion 29 of the hub 27. They are fixedly held on the hub 27. A positioning screw 37 is passed from above through the positioning hole 38 in the arm 30 of the HGA 35, a positioning hole 65 in the reinforcing plate 58, the positioning hole 51b in the spacer ring 34, and the positioning hole 65b in the reinforcing plate 58b. The screw 37 is screwed in the tapped hole 38b in the arm 30 of the HGA 35b. Thus, the arm 30, reinforcing plate 58, spacer ring 34, reinforcing plate 58b, and the other arm 30 are located in given relative positions with respect to the circumferential direction of the hub 27. The two arms 30 extend in the same direction from the hub 27 and can rock integrally with the hub. The respective magnetic heads 33 of the HGAs 35 and 35b are situated opposite each other.

The connecting end portion 54 of the main FPC 42 is connected to the head actuator 22. The projection 36 of the arm 30, the projection 62 of the reinforcing plate 58, a projection 48 of the spacer ring 34, the projection 62b of the reinforcing plate 58b, and the projection 36 of the other arm 30 are stacked on one another. The respective connecting portions 44 and 55 of the relay FPC 40 and the main FPC 42 are sandwiched between the respective projections 36 and 62 of the arm 30 and the reinforcing plate 58. Further, the connecting portions 44 and 55 and the projection 62 of the reinforcing plate 58 are sandwiched between the respective projections 36 and 48 of the arm 30 and the spacer ring 34. Thus, the connecting pads 45 on the connecting portion 44 and the connecting pads 56 on the connecting portion 55 are pressed against each other and connected mechanically and electrically.

Likewise, the respective connecting portions 44 and 55 of the relay FPC 40 of the HGA 35b and the main FPC 42 are sandwiched between the respective projections 36 and 62b of the arm 30 and the reinforcing plate 58b. Further, the connecting portions 44 and 55b and the projection 62b of the reinforcing plate 58b are sandwiched between the respective projections 36 and 48 of the arm 30 and the spacer ring 34. Thus, the connecting pads 45 on the connecting portion 44 and the connecting pads 56 on the connecting portion 55b are pressed against each other and connected mechanically and electrically.

In this manner, the head actuator 22 and the FPC unit 21 are connected electrically and mechanically to each other to form a head actuator assembly. Anisotropic conductive films may be sandwiched individually between the connecting portions 44 and 55 and between the connecting portions 44 and 55b in order to secure the electrical connection between the connecting pads 45 and 56.

The head actuator assembly constructed in this manner is located in a casing of an HDD, and the bearing assembly 26 of the actuator 22 is fixed on the bottom wall of the casing. Further, the base portion 52 of the FPC unit 21 is fixed on the bottom wall of the casing 12. If a voice coil 51 is energized when the HDD is on, the head actuator 22 rocks, whereupon the magnetic head 33 is moved onto and positioned on a desired track of a magnetic disk. The respective magnetic heads 33 of the HGAs 35 and 35b are opposed to each other with the magnetic disk between them and moved individually on the opposite surfaces of the disk. In this case, the magnetic disk used has magnetic recording layers on its opposite surfaces.

In the second embodiment arranged in this manner, the main FPC 42 and the relay FPC 40 can be also connected with ease and in a short time without using solder or the like. As this is done, the connecting portions 55 and 55b of the main FPC 42 and the connecting portion 44 of the relay FPC 40 can be positioned accurately and connected securely. Further, the connecting portions 55 and 55b of the main FPC 42 and the connecting portion 44 of the relay FPC 40 can be easily disconnected by removing the nut 68 of the bearing assembly 26 and disjoining the two arms 30, reinforcing plates 58 and 58b, and spacer ring 34. If the head actuator assembly breaks down, therefore, it can be easily repaired without damaging its components and other components of the HDD.

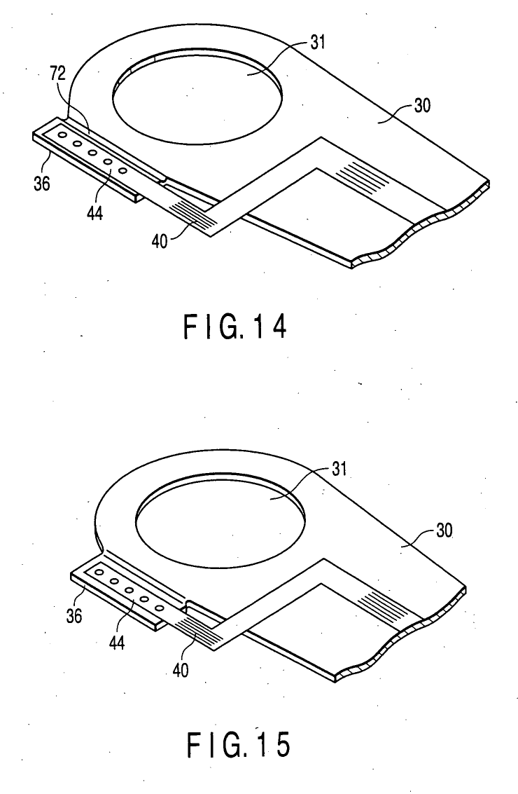

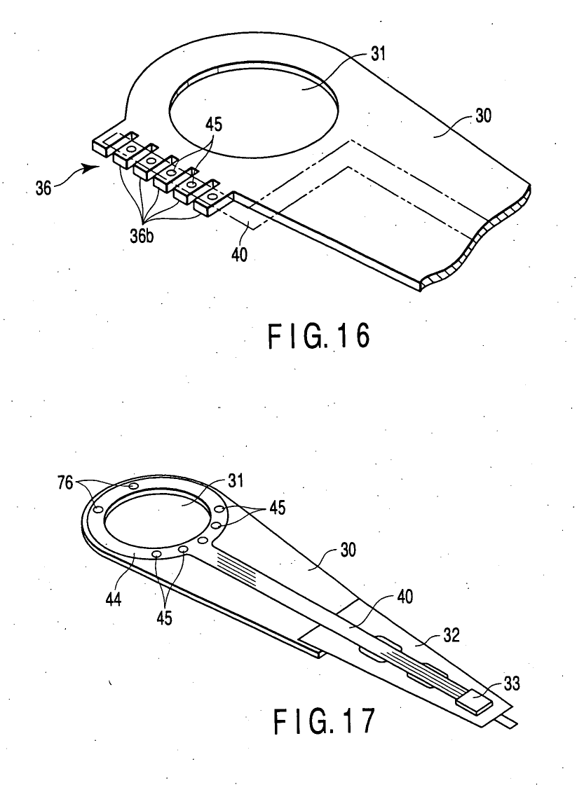

In the first and second embodiments described above, as shown in FIG. 13, the arm 30 of the HGA may have a slit 71 that is formed along the proximal end of projection 36. As shown in FIG. 14, the arm 30 of the HGA may have a groove 72 that is formed along the proximal end of the projection 36 by half-etching. Alternatively, as shown in FIG. 15, the projection 36 of the arm 30 may be made thinner than the other part of the arm by half-etching. In this case, a suitable step corresponding to the thickness of the relay FPC 40 may be formed on the projection 36. As shown in FIG. 16, the projection 36 of the arm 30 may be formed having a plurality of divisions 36b that face the connecting pads 45 of the relay FPC 40, individually, and are divided from one another.

If the arm 30 is stacked on the bearing assembly and sandwiched between the flange 28 and the nut 68, according to the configurations shown in FIGS. 13 to 16, the projection 36 can be easily elastically deformed by the resulting clamping force, so that the connecting portions 44 and 55 can be securely pressed against and connected to each other. According to the configuration shown in FIG. 16, moreover, the divisions 36b of the projection 36 can securely press their corresponding connecting pads.

In the first and second embodiments and the modifications shown in FIGS. 13 to 16, the projection 36 of the arm may be moderately bent in advance on the side of the spacer ring 34 or on the side of the connecting portion of the main FPC. When the head actuator is assembled, in this case, the projection 36 of the arm is elastically deformed from its bent position to a position such that it extends substantially parallel to the proximal end portion of the arm. Accordingly, the projection 36 generates a press force in a direction such that it returns to the bent position, and the connecting portion 44 of the relay FPC 40 is pressed against the connecting portion 55 of the main FPC 42 by the press force. Thus, the respective connecting portions 55 and 44 of the main FPC 42 and the relay FPC 40 can be connected more securely.

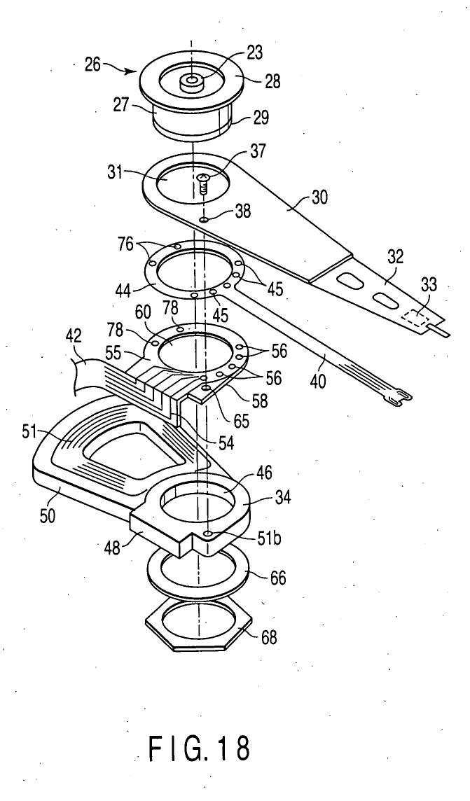

According to a third embodiment of the invention, as shown in FIGS. 17 and 18, a connecting portion 44 of a relay FPC 40 is in the form of a ring that extends around an opening 31 of an arm 30. The connecting portion 44 has a plurality of connecting pads 45 that are situated around the opening 31, and these connecting pads are connected to a conductor pattern of the relay FPC 40. The connecting portion 44 is provided with a plurality of dummy pads 76 that are situated substantially on the opposite side of the opening 31 to the connecting pads 45. These dummy pads 76 have the same height with the connecting pads 45 and are not connected to the conductor pattern.

A connecting portion 55 of a main FPC 42 is in the form of a ring that extends around an opening 60 of a reinforcing plate 58. The connecting portion 55 has a plurality of connecting pads 56 that are situated around the opening 60, and these connecting pads are connected to a conductor pattern of the main FPC 42. The connecting portion 55 is provided with a plurality of dummy pads 78 that are situated substantially on the opposite side of the opening 60 to the connecting pads 56. These dummy pads 78 have the same height with the connecting pads 56 and are not connected to the conductor pattern. The connecting pads 56 and the dummy pads 78 are located in positions corresponding individually to the connecting pads 45 and the dummy pads 76 of the relay FPC 40.

The arm 30, the reinforcing plate 58, and a spacer ring 34 are stacked on a hub 27 of a bearing assembly 26 and sandwiched between a nut 68 and a flange 28 of the bearing assembly. The respective connecting portions 44 and 55 of the relay FPC 40 and the main FPC 42 are sandwiched between the arm 30 and the reinforcing plate 58 and pressed against each other. Thus, the connecting pads 45 on the connecting portion 44 and the connecting pads 56 on the connecting portion 55 are brought into contact with and connected electrically to each other. As this is done, the dummy pads 76 on the connecting portion 44 and the dummy pads 78 on the connecting portion 55 are pressed against one another. Thereupon, the part that includes the connecting pads 45 and 56 is as thick as the part that includes the dummy pads 76 and 78. Thus, the connecting portions 44 and 55 are held under uniform pressure between the arm 30 and the reinforcing plate 58 throughout the circumference.

The third embodiment shares other configurations with the first embodiment. Like reference numerals are used to designate like portions of the first and third embodiments, and a detailed description of those portions is omitted. The third embodiment can provide the same functions and effects as those of the first embodiment.

It is to be understood that the present invention is not limited to the precise embodiments described above, and that various changes and modifications may be effected therein without departing from the scope of the invention. Further, various other inventions may be made by suitably combining the components described in connection with the foregoing embodiments. For example, some of the components according to the embodiments may be omitted. Further, the components according to different embodiments may be suitably combined as required. This invention is not limited to HDDs but is also applicable to any other disk drives, such as magneto-optical disk drives. Furthermore, the number of magnetic disks used in the magnetic disk drive is not limited to one but may be varied as required.

1. A head actuator assembly comprising:
an arm;
a cylindrical hub;
a relay flexible printed circuit (FPC) mounted on the arm and having a first connecting portion;
a main FPC having a second connecting portion for connection to the first connecting portion of the relay FPC;
a reinforcing plate having a first part with a circular opening and a second part with a projection, said second connecting portion of said relay FPC connected to said second part of said reinforcing plate for supporting said second connecting portion, said circular opening of said first part receiving said cylindrical hub for aligning said reinforcing plate with respect to said arm.

2. A head actuator assembly as recited in claim 1 wherein said arm has an circular opening, and said hub passes through said circular opening of said arm.

3. A head actuator assembly as recited in claim 2, wherein said arm has a positioning hole adjacent said circular opening of said arm and said reinforcing plate has a positioning hole adjacent said circular opening of said reinforcing plate.

4. A head actuator assembly as recited in claim 3 wherein said first connecting portion and said second connecting portion are electrically connected together and mechanically secured together without the use of solder or caulking.

5. A head actuator assembly as recited in claim 3 wherein a first end of said hub has a flange and a second end of said hub has a threaded portion, and said assembly has a nut for receiving said threaded portion, said hub passing through said circular opening of said arm and said circular opening of said reinforcing plate and threaded into said nut by said threaded portion for securing said arm and said reinforcing plate together.

6. A head actuator assembly as recited in claim 5 wherein said projection has a distal end bent at a right angle with respect to a plane of said circular opening of said reinforcing plate and said connecting portion of said main FPC has a first portion and a second portion bend at right angles with respect to the first portion, said first and second portions secured to a portion of said projection adjacent said distal end and said bent distal end respectively.

7. A head actuator assembly as recited in claim 1 wherein said first connecting portion and said second connecting portion each have connecting pads for facilitating electrical connection.

8. A head actuator assembly as recited in claim 1 wherein said arm has an arm projection and the arm has a slit formed along the proximal end of the arm projection.

9. A head actuator assembly as recited in claim 1, wherein said arm has an arm projection and the arm has a groove formed along the proximal end of the projection.

10. A head actuator assembly as recited in claim 1 wherein said arm has an arm projection and wherein the projection of the arm is made thinner than other parts of the arm.

11. A head actuator assembly as recited in claim 1 wherein:
the connecting portion of the main FPC has a plurality of connecting pads;
the connecting portion of the relay FPC has a plurality of connecting pads;
said arm has an arm projection;
the arm projection has a plurality of individual projecting members receiving the connecting pads of the connecting portion of the relay FPC, said individual projecting members positioned for connection to the connecting pads of said main FPC.

12. A head actuator assembly as recited in claim 1, wherein said arm has an arm projection and wherein the arm projection is bent toward said reinforcing plate thereby applying a press force to the connecting portion if said reinforcing plate.

13. A head actuator assembly as recited in claim 1 wherein the connecting portion of the main FPC has a first portion and a second portion and the reinforcing plate has a first plate portion extending parallel to the arm and a second plate portion extending at right angles to the first plate portion, the first and second portions of the connecting portion of the main FPC being fixed on the first plate portion and the second plate portion, respectively.

14. A head actuator assembly as recited in claim 2 wherein the connecting portion of the relay FPC extends in a ring around the circular opening of the arm, and the connecting portion of the main FPC extends in a ring around the circular opening of the reinforcing plate.

15. A head actuator assembly as recited in claim 2 wherein the connecting portion of the relay FPC has a plurality of connecting pads situated around the circular opening of the arm and connected electrically to the connecting portion of the main flexible printed circuit board and dummy pads situated around the opening of the arm.

16. A head actuator assembly comprising:
a plurality of arms;
a cylindrical hub;
a plurality of relay flexible printed circuits (FPCs), one flexible printed circuit (FPC) mounted on each of the plurality of arms, each FPC having a first connecting portion;
a main FPC having a second connecting portion for connection to each of the first connecting portion of the relay FPCs;
a reinforcing plate having a first part with a circular opening and a second part with a projection, said second connecting portion of said relay FPC connected to said second part of said reinforcing plate for supporting said second connecting portion, said circular opening of said first part receiving said cylindrical hub for aligning said reinforcing plate with respect to said arm.

17. A head actuator assembly as recited in claim 16 wherein each of said plurality of arms has an circular opening, and said hub passes through said circular openings of each of said arms.

18. A head actuator assembly as recited in claim 16, wherein each of said plurality of arms has a positioning hole adjacent said respective circular openings and said reinforcing plate has a positioning hole adjacent said circular opening of said reinforcing plate.

19. A head actuator assembly as recited in claim 18 wherein said first connecting portion and said second connecting portion are electrically connected together and mechanically secured together without the use of solder or caulking.

20. A head actuator assembly as recited in claim 18 wherein a first end of said hub has a flange and a second end of said hub has a threaded portion, and said assembly has a nut for receiving said threaded portion, said hub passing through said circular openings of each of said plurality of arms and said circular opening of said reinforcing plate and threaded into said nut by said threaded portion for securing said plurality of arms and said reinforcing plate together.

21. A disk drive comprising:
a disk;
a drive element which supports and rotates the disk;
a head which records in and reproduces information from the disk; and
the head actuator assembly according to claim 1, which supports the head on said arm for movement with respect to the disk and locates the head in an optional position relative to the disk.

22. A disk drive comprising:
a disk;
a drive element which supports and rotates the disk;
a plurality of heads which record in and reproduce information from the disk; and
the head actuator assembly according to claim 11, which supports the plurality of heads on respective ones of said plurality of arms for movement with respect to the disk and locates the head in an optional position relative to the disk.

23. A head actuator assembly comprising:
a head actuator which supports a head, the head actuator including:
a bearing portion,
an arm extending from the bearing portion and having a proximal end portion with an opening through which the bearing portion is passed,
a suspension extending from an extended end of the arm,
the head being provided on an extended end of the suspension,
a relay flexible printed circuit board mounted on the arm and the suspension and having one end portion connected electrically to the head and a connecting portion overlapping the proximal end portion of the arm,
a spacer member stacked on the proximal end portion of the arm and having an opening through which the bearing portion is passed; and
a reinforcing plate having an opening through which the bearing portion is passed; and
a main flexible printed circuit board connected to the head actuator, the main flexible printed circuit board having a connecting end portion provided with a connecting portion, said reinforcing plate fixed overlapping the connecting end portion and the connecting portion,
the reinforcing plate being stacked between the proximal end portion of the arm and the spacer member, the respective connecting portions of the relay flexible printed circuit board and the main flexible printed circuit board being sandwiched between the proximal end portion of the arm and the reinforcing plate and connected electrically to each other.

24. A head actuator assembly according to claim 23, wherein the proximal end portion of the arm has a projection projecting outward from the bearing portion, the connecting portion of the relay flexible printed circuit board is located overlapping the projection, the spacer member has a projection projecting outward from the bearing portion, and the respective connecting portions of the relay flexible printed circuit board and the main flexible printed circuit board are sandwiched between the respective projections of the arm and the spacer member.
